(19) United States
(12) Patent Application Publication
(10) Pub. No.: US 2014/0006044 A1
(43) Pub. Date: Jan. 2, 2014

(54) SYSTEM AND METHOD FOR PREPARING HEALTHCARE SERVICE BUNDLES

(71) Applicant: Infosys Limited, Bangalore (IN)

(72) Inventors: Satyabrata Pradhan, Orissa (IN); Radha Krishna Pisipati, Hyderabad (IN); Syed Mohammed, Hyderabad (IN)

(21) Appl. No.: 13/929,754

(22) Filed: Jun. 27, 2013

(30) Foreign Application Priority Data
Jun. 27, 2012 (IN) 2547/CHE/2012

(51) Int. Cl. G06F 19/00

(52) U.S. Cl. CPC G06F 19/3443
USPC 705/2

(57) ABSTRACT

The disclosed embodiment relates to a computer-implemented method, an apparatus, and computer-readable media for preparing medical treatment service bundles. An exemplary method comprises identifying historical medical treatments based on attributes of a patient's medical condition, the historical medical treatments being associated with existing claim records, deriving a common pattern based on the historical medical treatments, extracting potential medical treatments for the patient from the historical medical treatments based on the common pattern; determining whether the potential medical treatments are appropriate medical treatments for the patient based on the attributes of the patient's medical condition; and preparing a service bundle including the appropriate medical treatments for the patient.

### RELATED APPLICATION DATA

This application claims priority to India Patent Application No. 2547/CHE/2012, filed Jun. 27, 2012, the disclosure of which is hereby incorporated by reference in its entirety.

### TECHNICAL FIELD

The present invention relates to preparing medical treatment service bundles for use in estimating member liabilities for medical treatments.

### BACKGROUND

Most of the existing solutions in the health care domain for liability estimator focus on estimating the amount need to be spent towards a claim (patient's disease). In many cases, the procedures that need to be followed for a patient's condition are not known based on an initial diagnosis, and may not be known until much later.

Aetna has developed a solution call Member Payment Estimator for estimating the member liability. Pseudo claim approach is used to come up with the estimates. Solution Flow: The provider logs on the Navinet website and keys in the inputs. The claim adjudication programs are invoked through the MQ Series and the output details for provider, member, procedure and contracted amount, member responsibility amount are sent back to the website through MQ Series. The provider database, member database, plan and benefit database are accessed and then the estimates for the member responsibility are displayed (based on claim adjudication) along with the contracted amount and member and provider details. The estimates are provided for medical and hospital claims. The pharmacy and dental service related estimates are not covered.

Trizetto has also developed a solution for MLE. QNXT ver 4.7 has a facility to provide the estimates. The pseudo claim approach is used. The claim adjudication is used in the backend to come up with the estimates, so no difference between real values and the estimates. The provider contacts the customer service representative and provides the details for the claim, since QNXT does not have an online interface.

First National Merchant Solutions has a product for calculating the member estimates using their—First Paid Patient Responsibility Calculator. HealthCare Solutions Group's Real time Benefit Analyzer allows the user to compare diagnoses, services, and utilization patterns to identify opportunities for plan improvements.

### SUMMARY OF THE INVENTION

The disclosed embodiment relates to a computer-implemented method executed by one or more computing devices for preparing medical treatment service bundles. An exemplary method comprises identifying, by at least one of the one or more computing devices, one or more historical medical treatments based on one or more attributes of a patient's medical condition, wherein the one or more historical medical treatments are associated with one or more existing claim records, deriving, by at least one of the one or more computing devices, a common pattern based on at least one of the one or more historical medical treatments, extracting, by at least one of the one or more computing devices, one or more potential medical treatments for the patient from the one or more historical medical treatments based on the common pattern, determining, by at least one of the one or more computing device, whether at least one of the one or more potential medical treatments is an appropriate medical treatment for the patient based on at least one of the one or more attributes of the patient's medical condition, and preparing, by at least one of the one or more computing devices, a service bundle including at least one appropriate medical treatment for the patient.

In addition, the disclosed embodiment relates to an apparatus for preparing medical treatment service bundles. An exemplary apparatus comprises one or more processors, and one or more memories operatively coupled to at least one of the one or more processors and having instructions stored thereon that, when executed by at least one of the one or more processors, cause at least one of the one or more processors to identify one or more historical medical treatments based on one or more attributes of a patient's medical condition, wherein the one or more historical medical treatments are associated with one or more existing claim records, derive a common pattern based on at least one of the one or more historical medical treatments, extract one or more potential medical treatments for the patient from the one or more historical medical treatments based on the common pattern, determine whether at least one of the one or more potential medical treatments is an appropriate medical treatment for the patient based on at least one of the one or more attributes of the patient's medical condition, and prepare a service bundle including at least one appropriate medical treatment for the patient.

Furthermore, the disclosed embodiment relates to at least one non-transitory computer-readable medium storing computer-readable instructions that, when executed by one or more computing devices, cause at least one of the one or more computing devices to identify one or more historical medical treatments based on one or more attributes of a patient's medical condition, wherein the one or more historical medical treatments are associated with one or more existing claim records, derive a common pattern based on at least one of the one or more historical medical treatments, extract one or more potential medical treatments for the patient from the one or more historical medical treatments based on the common pattern, determine whether at least one of the one or more potential medical treatments is an appropriate medical treatment for the patient based on at least one of the one or more attributes of the patient's medical condition, and prepare a service bundle including at least one appropriate medical treatment for the patient.

As described herein, the historical medical treatments may be identified by procedure code, and the claim records may include claims from at least one of a professional provider and an institutional provider. In addition, the potential medical treatments can be determined to be an appropriate medical treatment for the patient based on a weighting assigned to the potential medical treatments. Also, an estimated cost for the appropriate medical treatments included in the service bundle can be determined, for example, based on factors such as the identity of expected medical treatment providers, the geographic location of the patient, and the timeframe for providing the appropriate medical treatment.

### BRIEF DESCRIPTION OF THE DRAWINGS

The above mentioned features as well other features, aspects, and advantages of the present invention will become better understood when the following detailed description is read with reference to the accompanying drawings in which like characters represent like parts throughout the drawings, wherein:

FIG. 1 is a flowchart illustrating an exemplary method for preparing service bundles according to the disclosed embodiment.

FIG. 2 is a flowchart illustrating an exemplary method for estimating the cost of a service bundle according to the disclosed embodiment.

FIG. 3 is a system illustrating a generalized computer network arrangement according to the disclosed embodiment.

### DETAILED DESCRIPTION

As described herein, there is a lack of system/tool which can predict the combination of procedures a patient is expected to go through according to his present condition accurately. This is generally called as service bundle. The existing solutions in liability estimation don't have mechanisms to obtain service bundles. Thus, the present invention provides a method and system for pattern extraction and estimation of member liability of an insurance payer. The payer of a healthcare insurance preferably opt a plan among service bundles exist with the insurance provider, and the estimation of payer's liability is carried out based on the treatment and diagnosis required. Common patterns are extracted by mining service bundles data from the historical insurance claim records. The method provided has a two-level association rule mining to obtain co-occurring procedure codes. The method provided also has clustering approach to detect the right group (or service bundle) for a claim in order to conduct highly accurate price estimation. Cost of procedure(s) is estimated according to demographic and geographic existence of the patient and location of the service center. The system provided facilitates price estimation and individual payer's liability estimation by finding co-occurring procedure codes for service bundles as per the proposed claim for a certain disease.

To achieve this result, the disclosed embodiment utilizes a hybrid model for calculating member liability which is preferably based on a mix of statistical model and claim adjudication. Specifically, the models utilizes a data mining approach for automated generation of service bundles from history record of patients, progressive generation of revised service bundles based on partial current medical records of a patient, hierarchical procedures to obtain service bundles based on critical parameter in medial domain, and a stochastic approach to obtain price estimates for medical procedures conducted on a patients. In addition, hierarchical procedures can be followed for obtaining the service bundles and price estimation of the same for patient, clustering and frequent set mining based approach can be used to pre-generate service bundles and progressive generation of service bundles based on update information on patients, and stochastic approaches to obtain price estimation of treatment. Using these tools, insurance providers, for example, as well as patients themselves, can generate highly accurate estimation on treatment details along with price estimation.

According to the disclosed embodiment, common patterns can be extracted from among the important attributes and obtain all possible service bundles if exist in the history records of claims. Also, progressive estimation in terms of service bundles can be generated based on updated information on current medical report of a patient. The estimated cost of procedure(s), according to demographic/geographic existence of the patient and location of the service center based on a time horizon, can also be determined.

Pattern Extraction: Service Bundles Generation

Mining service bundles is preferably two step cascading approach. In each step, association rule mining is performed using some attributes on claims' history data based on certain condition(s). First, the common patterns are identified among the attributes like diagnosis code, procedure code and place of service, modifier and revenue code, conditioned upon provider entity. Next, for a certain combination from the above patterns, possible hidden combinations of procedures conducted under a claim, i.e. service bundles, can be identified.

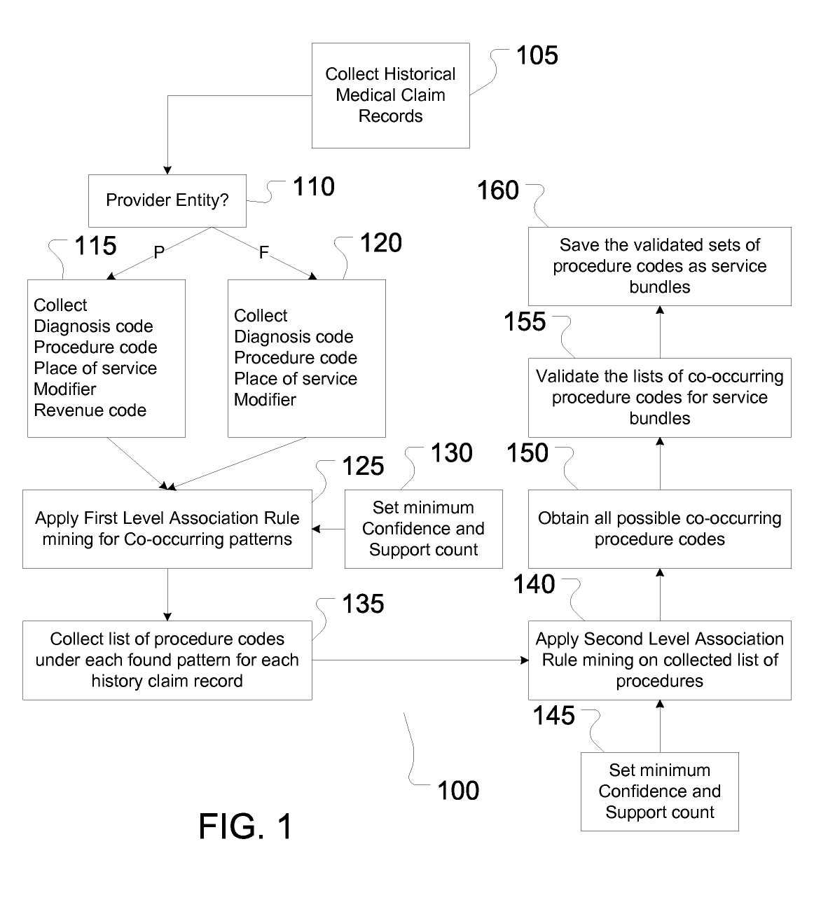

As shown in the FIG. 1, which shows an exemplary flow chart 100 for preparing service bundles, historical data for the claims is collected in step 105 and pre-analysis is done. In step 110, the provider entity is identified as either professional claims (“P”) or institutional claims (“F”). In the given input data, there is typically huge number of attributes 115 or 120 which when considered increases the time and space complexity. To simplify the calculations without losing out the information, the best correlated attributes are identified. For each attribute, a correlation is found between that attribute and the remaining attributes. Then top ranked attributes having highest correlation coefficient are selected. This procedure is repeated with other attributes. Determining the intersection among the highly correlated attributes yields the best possible set of important attributes to be considered for analysis.

In step 125, the final set of attribute's data is given as input for first level association rule mining to generate frequent pattern sets. A minimum confidence and support count 130 can be set. Of the many frequent patterns generated, for any given pattern, corresponding procedure codes are identified in step 135. These procedure codes are given as input for second level association rule mining in step 140 to generate frequent pattern sets among the procedure codes. Again, a minimum confidence and support count 145 can be set. Then, all possible co-occurring procedure codes are obtained in step 150, the lists of co-occurring procedure codes are validated for use in service bundles in step 155, and the validated sets of procedure codes are saved as service bundles in step 160.

The disclosed embodiment further relates to a computer-implemented method executed by one or more computing devices for preparing medical treatment service bundles. An exemplary method comprises identifying, by at least one of the one or more computing devices, one or more historical medical treatments based on one or more attributes of a patient's medical condition, wherein the one or more historical medical treatments are associated with one or more existing claim records, deriving, by at least one of the one or more computing devices, a common pattern based on at least one of the one or more historical medical treatments, extracting, by at least one of the one or more computing devices, one or more potential medical treatments for the patient from the one or more historical medical treatments based on the common pattern, determining, by at least one of the one or more computing device, whether at least one of the one or more potential medical treatments is an appropriate medical treatment for the patient based on at least one of the one or more attributes of the patient's medical condition, and preparing, by at least one of the one or more computing devices, a service bundle including at least one appropriate medical treatment for the patient.

In addition, the disclosed embodiment relates to an apparatus for preparing medical treatment service bundles. An exemplary apparatus comprises one or more processors, and one or more memories operatively coupled to at least one of the one or more processors and having instructions stored thereon that, when executed by at least one of the one or more processors, cause at least one of the one or more processors to identify one or more historical medical treatments based on one or more attributes of a patient's medical condition, wherein the one or more historical medical treatments are associated with one or more existing claim records, derive a common pattern based on at least one of the one or more historical medical treatments, extract one or more potential medical treatments for the patient from the one or more historical medical treatments based on the common pattern, determine whether at least one of the one or more potential medical treatments is an appropriate medical treatment for the patient based on at least one of the one or more attributes of the patient's medical condition, and prepare a service bundle including at least one appropriate medical treatment for the patient.

Furthermore, the disclosed embodiment relates to at least one non-transitory computer-readable medium storing computer-readable instructions that, when executed by one or more computing devices, cause at least one of the one or more computing devices to identify one or more historical medical treatments based on one or more attributes of a patient's medical condition, wherein the one or more historical medical treatments are associated with one or more existing claim records, derive a common pattern based on at least one of the one or more historical medical treatments, extract one or more potential medical treatments for the patient from the one or more historical medical treatments based on the common pattern, determine whether at least one of the one or more potential medical treatments is an appropriate medical treatment for the patient based on at least one of the one or more attributes of the patient's medical condition, and prepare a service bundle including at least one appropriate medical treatment for the patient.

As described herein, the historical medical treatments may be identified by procedure code, and the claim records may include claims from at least one of a professional provider and an institutional provider. In addition, the potential medical treatments can be determined to be an appropriate medical treatment for the patient based on a weighting assigned to the potential medical treatments. Also, an estimated cost for the appropriate medical treatments included in the service bundle can be determined, for example, based on factors such as the identity of expected medical treatment providers, the geographic location of the patient, and the timeframe for providing the appropriate medical treatment.

In an alternative approach, service bundles can be progressively generated based on the current health and treatment information of the patient. Based on the current information, the best suitable frequent sets of procedures are identified that are likely for the partial information updated at a current point of time.

Price Estimation: For Procedure(s) Under a Service Bundle

In addition, as disclosed herein, prices for service bundles can be estimated based on various attributes like zip code, chain of service centers, time horizon. Furthermore, clustering techniques can be applied to find the right group for a certain claim, to conduct highly accurate price estimation. Time series analysis is also suitable for price estimation of procedure cost seems to change over the time.

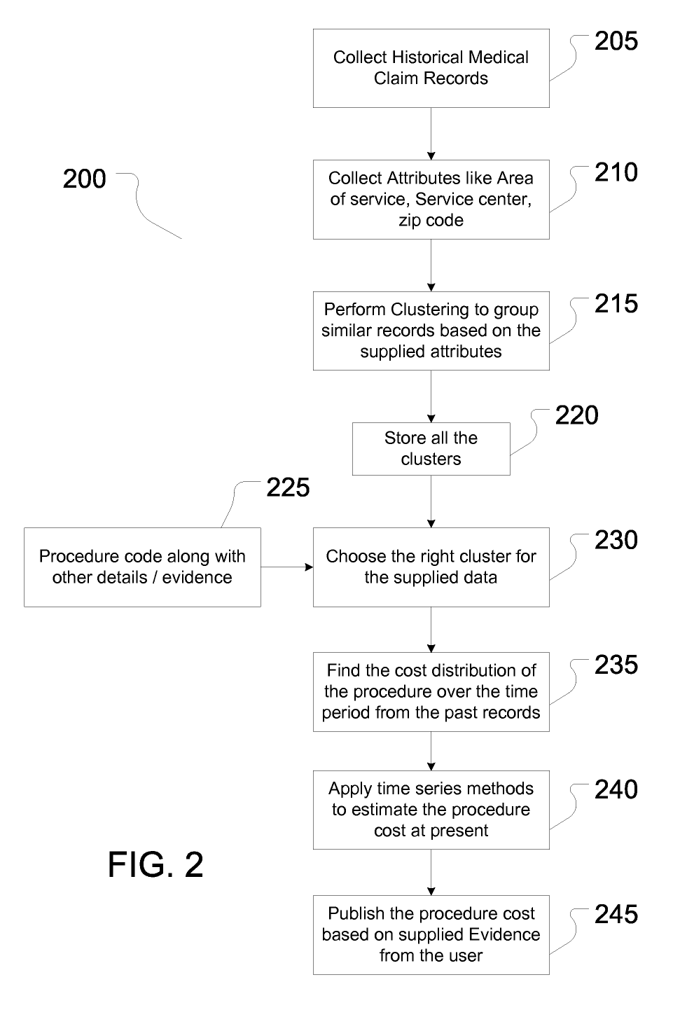

More specifically, as shown in FIG. 2, which shows an exemplary flow chart 200 for estimating costs, steps 205 and 210 includes collecting historical medical claim records and attributes like area of service, service center, zip code, and the like. In step 215, clustering is performed to group similar records based on the supplied attributes, and the clusters are stored in step 220. Then, using procedure code along with other details/evidence supplied in step 225, the right cluster for the supplied data can be chosen in step 230. The cost distribution of the procedure over the time period can be determined in step 235 from the past records, and time series methods can be applied to estimate the procedure cost at present in step 240. Then, the estimated procedure cost can be published based on supplied evidence from the user in step 245.

Exemplary Computing Environment

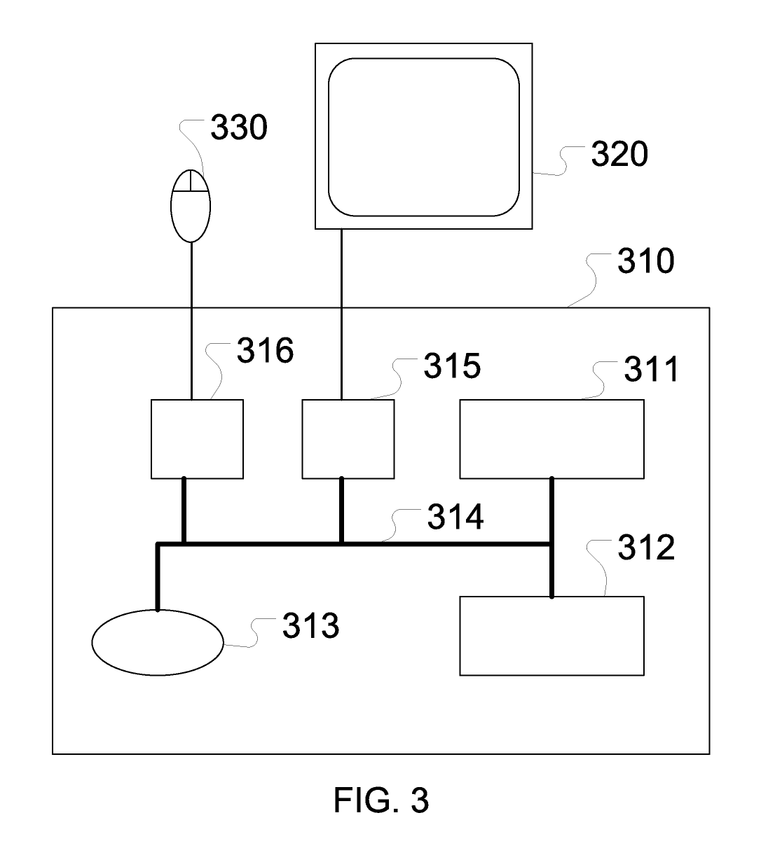

The embodiments described herein may be implemented with any suitable hardware and/or software configuration, including, for example, modules executed on computing devices such as computing device 310 of FIG. 3. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 310 has one or more processing device 311 designed to process instructions, for example computer readable instructions (i.e., code) stored on a storage device 313. By processing instructions, processing device 311 may perform the steps set forth in the methods described herein. Storage device 313 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 310 additionally has memory 312, an input controller 316, and an output controller 315. A bus 314 operatively couples components of computing device 310, including processor 311, memory 312, storage device 313, input controller 316, output controller 315, and any other devices (e.g., network controllers, sound controllers, etc.). Output controller 315 may be operatively coupled (e.g., via a wired or wireless connection) to a display device 320 (e.g., a monitor, television, mobile device screen, touch-display, etc.) in such a fashion that output controller 315 can transform the display on display device 320 (e.g., in response to modules executed). Input controller 316 may be operatively coupled (e.g., via a wired or wireless connection) to input device 330 (e.g., mouse, keyboard, touch-pad, scroll-ball, touch-display, etc.) in such a fashion that input can be received from a user (e.g., a user may input with an input device 330 a dig ticket).

Of course, FIG. 3 illustrates computing device 310, display device 320, and input device 330 as separate devices for ease of identification only. Computing device 310, display device 320, and input device 330 may be separate devices (e.g., a personal computer connected by wires to a monitor and mouse), may be integrated in a single device (e.g., a mobile device with a touch-display, such as a Smartphone or a tablet), or any combination of devices (e.g., a computing device operatively coupled to a touch-screen display device, a plurality of computing devices attached to a single display device and input device, etc.). Computing device 310 may be one or more servers, for example a farm of networked servers, a clustered server environment, or a cloud network of computing devices.

While systems and methods are described herein by way of example and embodiments, those skilled in the art recognize that the systems and methods for measuring camber are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A computer-implemented method executed by one or more computing devices for preparing medical treatment service bundles, the method comprising:
identifying, by at least one of the one or more computing devices, one or more historical medical treatments based on one or more attributes of a patient's medical condition, wherein the one or more historical medical treatments are associated with one or more existing claim records;
deriving, by at least one of the one or more computing devices, a common pattern based on at least one of the one or more historical medical treatments;
extracting, by at least one of the one or more computing devices, one or more potential medical treatments for the patient from the one or more historical medical treatments based on the common pattern;
determining, by at least one of the one or more computing device, whether at least one of the one or more potential medical treatments is an appropriate medical treatment for the patient based on at least one of the one or more attributes of the patient's medical condition; and
preparing, by at least one of the one or more computing devices, a service bundle including at least one appropriate medical treatment for the patient.

2. The computer-implemented method of claim 1, wherein the historical medical treatments are identified by procedure code.

3. The computer-implemented method of claim 1, wherein the claim records include claims from at least one of a professional provider and an institutional provider.

4. The computer-implemented method of claim 1, wherein at least one of the one or more potential medical treatments is determined to be an appropriate medical treatment for the patient based on a weighting assigned to the at least one potential medical treatment.

5. The computer-implemented method of claim 1, further comprising determining an estimated cost for at least one of the appropriate medical treatments included in the service bundle.

6. The computer-implemented method of claim 5, wherein the estimated cost is based on at least one of the identity of one or more expected medical treatment provider, the geographic location of the patient, and the timeframe for providing the appropriate medical treatment.

7. An apparatus for preparing medical treatment service bundles, the apparatus comprising:
one or more processors; and
one or more memories operatively coupled to at least one of the one or more processors and having instructions stored thereon that, when executed by at least one of the one or more processors, cause at least one of the one or more processors to:
identify one or more historical medical treatments based on one or more attributes of a patient's medical condition, wherein the one or more historical medical treatments are associated with one or more existing claim records;
derive a common pattern based on at least one of the one or more historical medical treatments;
extract one or more potential medical treatments for the patient from the one or more historical medical treatments based on the common pattern;
determine whether at least one of the one or more potential medical treatments is an appropriate medical treatment for the patient based on at least one of the one or more attributes of the patient's medical condition; and
prepare a service bundle including at least one appropriate medical treatment for the patient.

8. The apparatus of claim 7, wherein the historical medical treatments are identified by procedure code.

9. The apparatus of claim 7, wherein the claim records include claims from at least one of a professional provider and an institutional provider.

10. The apparatus of claim 7, wherein at least one of the one or more potential medical treatments is determined to be an appropriate medical treatment for the patient based on a weighting assigned to the at least one potential medical treatment.

11. The apparatus of claim 7, wherein at least one of the one or more memories has further instructions stored thereon that, when executed by at least one of the one or more processors, cause at least one of the one or more processors to determine an estimated cost for at least one of the appropriate medical treatments included in the service bundle.

12. The computer-implemented method of claim 11, wherein the estimated cost is based on at least one of the identity of one or more expected medical treatment provider, the geographic location of the patient, and the timeframe for providing the appropriate medical treatment.

13. At least one non-transitory computer-readable medium storing computer-readable instructions that, when executed by one or more computing devices, cause at least one of the one or more computing devices to:
Identify one or more historical medical treatments based on one or more attributes of a patient's medical condition, wherein the one or more historical medical treatments are associated with one or more existing claim records;
derive a common pattern based on at least one of the one or more historical medical treatments;
extract one or more potential medical treatments for the patient from the one or more historical medical treatments based on the common pattern;
determine whether at least one of the one or more potential medical treatments is an appropriate medical treatment for the patient based on at least one of the one or more attributes of the patient's medical condition; and
prepare a service bundle including at least one appropriate medical treatment for the patient.

14. The at least one non-transitory computer-readable medium of claim 13, wherein the historical medical treatments are identified by procedure code.

15. The at least one non-transitory computer-readable medium of claim 13, wherein the claim records include claims from at least one of a professional provider and an institutional provider.

16. The at least one non-transitory computer-readable medium of claim 13, wherein at least one of the one or more potential medical treatments is determined to be an appropriate medical treatment for the patient based on a weighting assigned to the at least one potential medical treatment.

17. The at least one non-transitory computer-readable medium of claim 13, further storing computer-readable instructions that, when executed by at least one of the one or more computing devices, cause at least one of the one or more computing devices to determine an estimated cost for at least one of the appropriate medical treatments included in the service bundle.

18. The at least one non-transitory computer-readable medium of claim 17, wherein the estimated cost is based on at least one of the identity of one or more expected medical treatment provider, the geographic location of the patient, and the timeframe for providing the appropriate medical treatment.
